(19) United States
(12) Patent Application Publication
(10) Pub. No.: US 2016/0085114 A1
(43) Pub. Date: Mar. 24, 2016

(54) DISPLAY DEVICE

(71) Applicant: Japan Display Inc., Tokyo (JP)

(72) Inventors: Shinichiro OKA, Tokyo (JP); Takahiro Ishinabe, Tokyo (JP); Hideo Fujikake, Tokyo (JP)

(21) Appl. No.: 14/858,426

(22) Filed: Sep. 18, 2015

(30) Foreign Application Priority Data
Sep. 19, 2014 (JP) 2014-191310

(51) Int. Cl. G02F 1/1335

(52) U.S. Cl. CPC G02F 1/133528; G02F 1/133504; G02F 2001/133541; G02F 2001/133562

(57) ABSTRACT

A display device includes a display panel and a backlight. The display panel has the first substrate, the second substrate, a liquid crystal layer sandwiched between the first and second substrates, the first circularly polarizing plate arranged on the observer's side of the first substrate, the second circularly polarizing plate arranged between the second substrate and the backlight, and a scattering film arranged on the observer's side of the first circularly polarizing plate.

### CLAIM OF PRIORITY

The present application claims priority from Japanese patent application No. JP2014-191310 filed on Sep. 19, 2014, the content of which is hereby incorporated by reference into this application.

### BACKGROUND

This disclosure relates to a display device and can be applied to a display device using a scattering film, for example.

For example, Japanese Patent Application Laid-Open Publication No. H6-230356 (Patent Literature 1) describes the following. “A liquid crystal display device is provided that aims to enlarge the viewing angle characteristics by a diffusion film and aims to improve the resolution.” “A liquid crystal layer 3 is sandwiched between two transparent substrates 2a and 2b, and polarizing plates 4a and 4b are arranged on both sides thereof. On the surface of the front polarizing plate 4a, a diffusion film 5 is further provided. The front-side transparent substrate 2a is formed to have a thickness of 0.1 to 0.3 mm.”

### SUMMARY

The inventor of the present application studied a display device using a scattering film (diffusion film), and found the following problem.

That is, when the display device using the scattering film is observed while external light is made incident on that display device under the sun or a fluorescent lamp, the entire display device appears in white.

Other problems and novel features will become apparent from the description of this disclosure and the accompanying drawings.

The outline of a typical portion of this disclosure is briefly described below.

A display device includes a display panel and a backlight. The display panel includes the first substrate, the second substrate, a liquid crystal layer sandwiched between the first and second substrates, the first circularly polarizing plate arranged on the observer's side of the first substrate, the second circularly polarizing plate arranged between the second substrate and the backlight, and a scattering film arranged on the observer's side of the circularly polarizing plate.

### BRIEF DESCRIPTION OF THE DRAWINGS

FIG. 1 is a cross-sectional view for explaining a display device according to Comparative Example 1.

FIG. 2 is a schematic diagram for explaining a problem of the display device according to Comparative Example 1.

FIG. 3 is a cross-sectional view for explaining a display device according to Comparative Example 2.

FIG. 4 is a cross-sectional view for explaining a display device according to an embodiment.

FIG. 5 is a cross-sectional view for explaining a circularly polarizing plate of the display device according to the embodiment.

FIG. 6 is a schematic diagram for explaining a right-handed circularly polarizing plate.

FIG. 7 is a schematic diagram for explaining a left-handed circularly polarizing plate.

FIG. 8 is a schematic diagram for explaining reflection of external light in the display device according to Comparative Example 1.

FIG. 9 is a schematic diagram for explaining effects of the display device according to the embodiment.

FIG. 10 is a schematic diagram for explaining a display device according to Modified Example 1.

FIG. 11 is a schematic diagram for explaining effects of the display device according to Modified Example 1.

FIG. 12 is a cross-sectional view for explaining the display device according to Modified Example 1.

FIG. 13 shows a simulation model.

FIG. 14 shows a calculation result of a contrast-ratio chart.

FIG. 15 shows viewing angle characteristics of a contrast ratio at an azimuth angle of 45 degrees.

FIG. 16 is a schematic diagram for explaining a display device according to Modified Example 2.

FIG. 17 is a cross-sectional view for explaining the display device according to Modified Example 2.

FIG. 18 is a cross-sectional view for explaining a broad-band circularly polarizing plate according to Modified Example 3.

FIG. 19 is a schematic diagram for explaining the broad-band circularly polarizing plate according to Modified Example 3.

FIG. 20 is a cross-sectional view for explaining a display device according to Modified Example 3.

FIG. 21 is a cross-sectional view for explaining a display device according to Modified Example 4.

FIG. 22 is a schematic diagram for explaining effects of the display device according to Modified Example 4.

FIG. 23 is a schematic diagram for explaining the display device according to Modified Example 3.

### DESCRIPTION OF THE PREFERRED EMBODIMENTS

An embodiment, comparative examples, and examples are described below with reference to the drawings. The disclosure is merely an example, and modifications that could be easily conceived by a person skilled in the art as appropriate while keeping the summary of the invention should be contained in the scope of the present invention. The drawings may show the width, thickness, shape, and the like of each component more schematically as compared with those in an actual embodiment for making the description clearer, but merely show an example and are not intended to limit the interpretation of the present invention. Moreover, in this specification and each drawing, the same components as those described in connection with a drawing referred to before are labeled with the same reference signs, and the detailed description thereof may be omitted as appropriate.

### Comparative Example

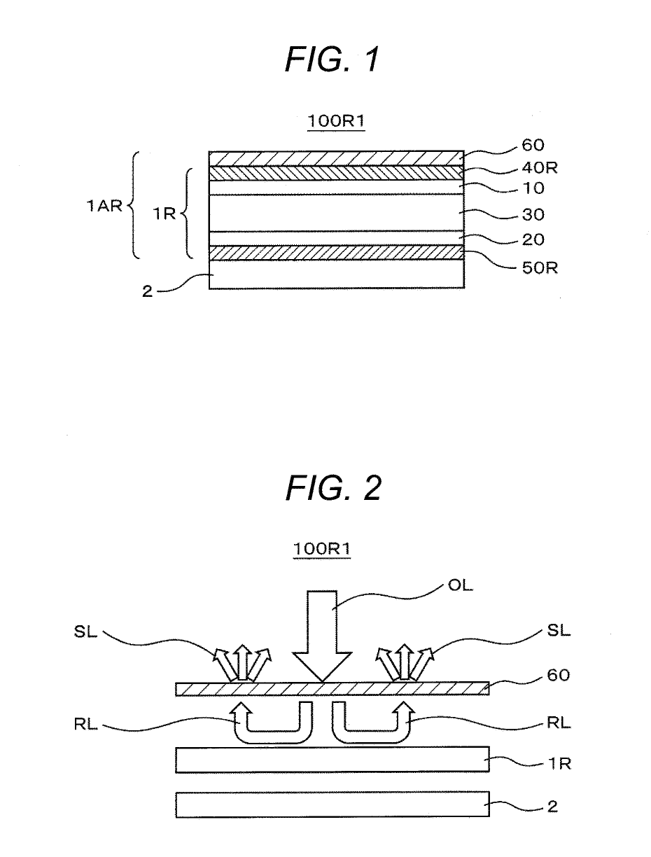

First, a technique studied before this disclosure (hereinafter, referred to as Comparative Example 1) and a general technique (hereinafter, referred to as Comparative Example 2) are described with reference to FIGS. 1 to 2.

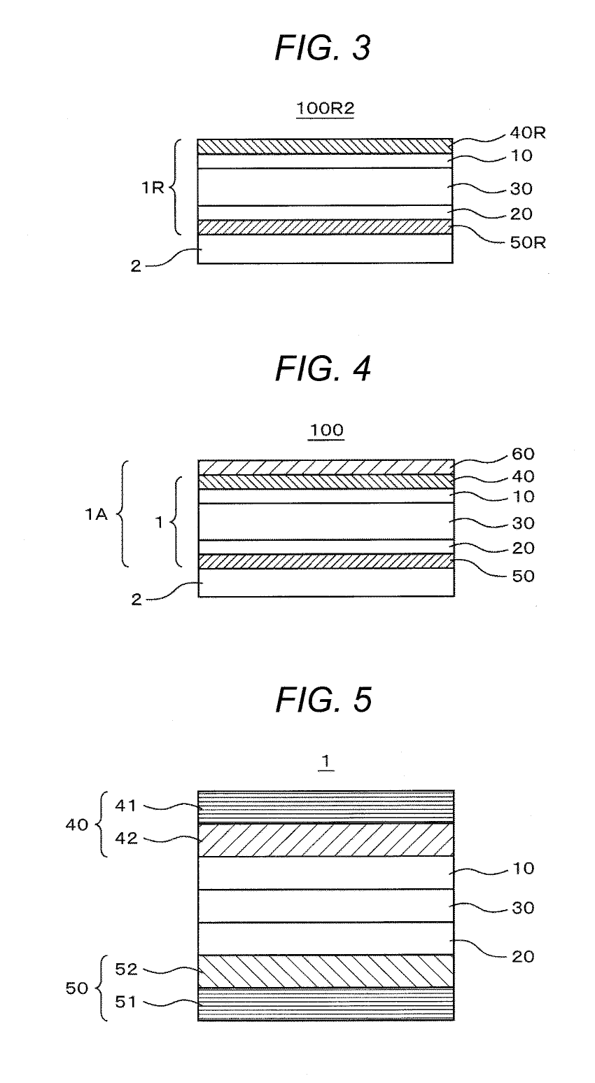

FIG. 1 is a cross-sectional view for explaining a display device according to Comparative Example 1. FIG. 2 is a conceptual view for explaining a problem of the display device according to Comparative Example 1. FIG. 3 is a cross-sectional view for explaining a display device according to Comparative Example 2.

A display device 100R1 according to Comparative Example 1 includes a display panel 1AR and a backlight 2 that is a light source for display attached on the opposite side to an observer's side. As shown in FIG. 1, the display panel 1AR includes a first substrate 10, a second substrate 20, a liquid crystal layer 30 sandwiched between the first substrate 10 and the second substrate 20, a first linearly polarizing plate 40R, a second linearly polarizing plate 50R, and a scattering film 60. The first linearly polarizing plate 40R is attached onto the observer's side of the first substrate 10. The second linearly polarizing plate 50R is attached onto the backlight 2 side of the second substrate 20. The scattering film 60 is attached onto the observer's side of the first linearly polarizing plate 40R. To the first substrate 10, a color filter for providing colors and an alignment film for aligning liquid crystal molecules are attached, for example. To the second substrate 20, an electrode formed of ITO (Indium Tin Oxide) or the like for driving the liquid crystal molecules, TFTs (Thin Film Transistors), and an alignment film for aligning the liquid crystal molecules are attached, for example. The color filter may be attached to the second substrate 20.

A display device 100R2 of Comparative Example 2 includes a display panel 1R and the backlight 2 attached onto the opposite side to the observer's side. As shown in FIG. 3, the display panel 1R includes the first substrate 10, the second substrate 20, the liquid crystal layer 30 sandwiched between the first substrate 10 and the second substrate 20, the first linearly polarizing plate 40R, and the second linearly polarizing plate 50R. The first linearly polarizing plate 40R is attached onto the observer's side of the first substrate 10. The second linearly polarizing plate 50R is attached onto the backlight 2 side of the second substrate 20. That is, the display panel 1AR of the display device 100R1 is the one obtained by attaching the scattering film 60 to the first polarizing plate 40R of the display panel 1R of the display device 100R2.

When the display device 100R1 is observed while it is placed under the sun or a fluorescent lamp to make external light (from the sun or the fluorescent lamp) incident thereon, it is found that the entire display device 100R1 appears in white. The principle for this phenomenon is considered as follows. As shown in FIG. 2, when external light OL is incident, it is reflected by the uppermost surface of the scattering film first, although not shown. The light transmitted through the scattering film 60 while being scattered thereby reaches the display panel 1R (that corresponds to the display panel 1AR from which the scattering film 60 is removed). Since the display panel 1R uses a transparent electrode having a high refractive index, such as ITO, the external light OL is strongly reflected. The reflected light RL is then transmitted through the scattering film 60 while being scattered, thereby becoming scattered light SL. Thus, the entire display panel 1AR appears in white. Please note that although the same phenomenon occurs in the display device 100R2, the entire panel does not appear in white. This is because the display device 100R2 does not include the scattering film 60 in its uppermost surface and therefore almost no reflection occurs other than regular reflection.

### Embodiment

Next, a display device according to an embodiment is described with reference to FIGS. 4 to 7.

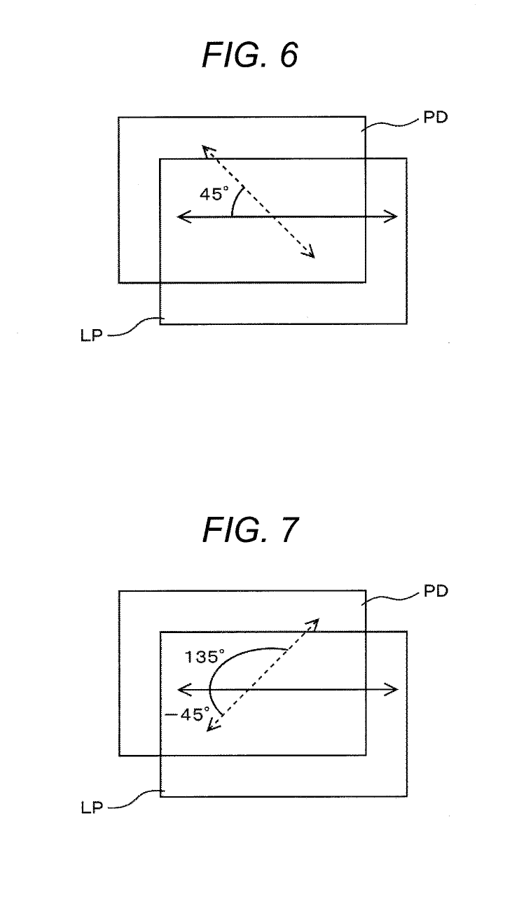

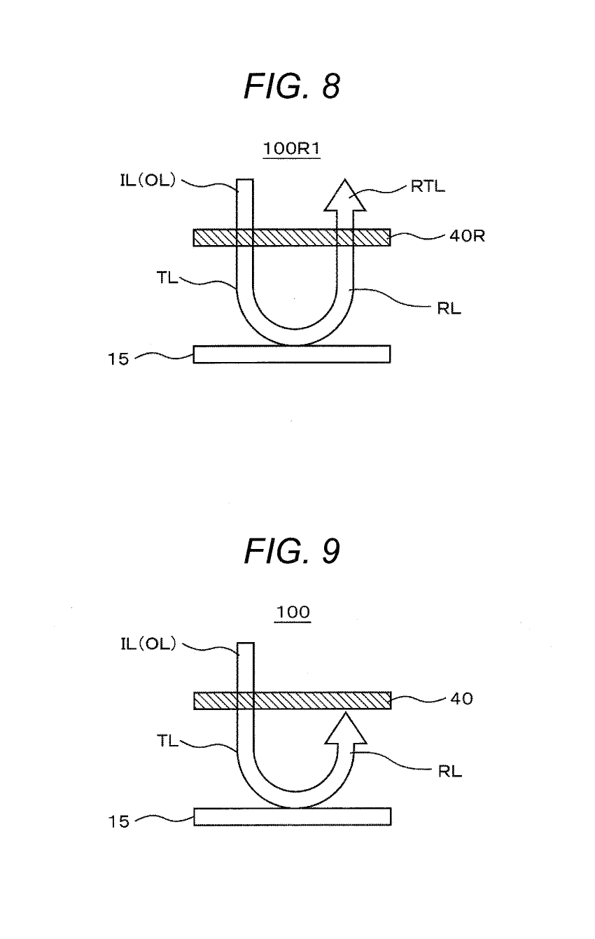

FIG. 4 is a cross-sectional view for explaining the display device according to the embodiment. FIG. 5 is a cross-sectional view for explaining a circularly polarizing plate of the display device according to the embodiment. FIG. 6 is a schematic diagram for explaining a right-handed circularly polarizing plate. FIG. 7 is a schematic diagram for explaining a left-handed circularly polarizing plate. FIG. 8 is a schematic diagram for explaining reflection of external light in the display device according to Comparative Example 1. FIG. 9 is a schematic diagram for explaining effects of the display device according to the embodiment.

The display device 100 according to the embodiment includes a display panel 1A and a backlight 2 that is attached onto the opposite side of the observer's side and is a light source for display. The display panel 1A includes a first substrate 10, a second substrate 20, a liquid crystal layer 30 sandwiched between the first substrate 10 and the second substrate 20, a first circularly polarizing plate 40, a second circularly polarizing plate 50, and a scattering film 60. The first circularly polarizing plate 40 is attached to the observer's side of the first substrate 10. The second circularly polarizing plate 50 is attached to the backlight 2 side of the second substrate 20. Although the scattering film 60 is attached to the observer's side of the first circularly polarizing plate 40 in the present embodiment, the same effects can be obtained when the scattering film 60 is attached to the backlight side. Please note that a display panel corresponding to the display panel 1A from which the scattering film 60 is removed is referred to as a display panel 1.

As a driving method of the display device 100 according to the embodiment, typical driving modes such as an IPS mode, a VA mode, and a TN mode, can be applied. For example, in a case of the VA mode, liquid crystal molecules can be aligned with the normal directions of the first substrate 10 and the second substrate 20 in initial alignment, and optical axes of retardation plates that respectively form the first circularly polarizing plate 40 arranged on the first substrate side and the second circularly polarizing plate 50 arranged on the second substrate 20 side can be arranged to be approximately orthogonal to each other. Please note that being approximately orthogonal means a formed angle is in a range of 90 degrees, plus or minus less than 5 degrees. It is preferable that an error from the strict angle is in a range of plus or minus less than 3 degrees. Also in the IPS mode or the TN mode, the directions of the optical axes can be selected such that white and black can be displayed in the same manner. In the display device 100 according to the embodiment, the display mode of the liquid crystal and the directions of the optical axes of the circularly polarized plates are not specifically limited. Support substrates included in the first substrate 10 and the second substrate 20 are desirably transparent, and glass, plastic, or the like can be used therefor. As shown in FIG. 5, the first circularly polarizing plate 40 has a structure in which a retardation plate providing a phase difference of λ/4 (a quarter-wave plate) 42 is bonded to a commonly used linearly polarizing plate 41 using iodine. The second circularly polarizing plate 50 has a structure in which a quarter-wave plate 52 is bonded to a commonly used linearly polarizing plate 51 using iodine. In the first circularly polarizing plate 40, the quarter wave plate 42 is arranged on the side on which light from the backlight 2 is incident while the linearly polarizing plate 41 is arranged on the exiting side (observer's side). In the second circularly polarizing plate 50, the linearly polarizing plate 51 is arranged on the side on which light from the backlight 2 is incident while the quarter wave plate 52 is arranged on the exiting side. In a case where the circularly polarizing plate is formed by a right-handed circularly polarizing plate, as shown in FIG. 6, the optical axis of the quarter-wave plate PD is arranged at an angle of approximately 45 degrees to the optical axis of the linearly polarizing plate LP. Please note that approximately 45 degrees is in a range of 45 degrees, plus or minus less than 5 degrees. It is preferable that an error with respect to the strict angle is in a range of plus or minus less than 3 degrees. In a case where the circularly polarizing plate is formed by a left-handed circularly polarizing plate, as shown in FIG. 7, the optical axis of the quarter-wave plate PD is arranged at an angle of approximately 135 degrees (−45 degrees) to the optical axis of the linearly polarizing plate LP. Please note that approximately 135 degrees (−45 degrees) is in a range of 135 degrees (−45 degrees), plus or minus less than 5 degrees. It is preferable that an error with respect to the strict angle is in a range of plus or minus less than 3 degrees. Moreover, in a case of the VA mode, for example, the rotation direction of the first circularly polarizing plate 40 and that of the second circularly polarizing plate 50 are set to be opposite to each other. For example, in a case where the first circularly polarizing plate 40 is formed by a right-handed circular polarizing plate, the left-handed circularly polarizing plate is used as the second circularly polarizing plate 50. Although the polarizing plate is formed by iodine in the above description, dye-based material can be used, as long as the same effects can be obtained.

The scattering film 60 is formed of polyester resin, polyvinyl chloride resin, or acrylic resin described in Patent Literature 1, for example, and is formed by transparent resin with white pigment mixed therein having a roughened surface. Moreover, particles having a different refractive index from that of the medium may be dispersed in the medium. The backlight 2 can be a general backlight formed by an LED, a light guide, or a prism sheet, and is not specifically limited.

In a case of using a usual polarizing plate (linearly polarizing plate) as in the display device 100R1 of Comparative Example 1, as shown in FIG. 8, transmitted light TL that corresponds to the incident light IL (external light OL) transmitted through the first linearly polarizing plate 40R is reflected by a reflection plate 15, and the reflection light RL is transmitted through the first linearly polarizing plate 40R, thereby becoming transmitted light RTL. However, in a case of using a circularly polarizing plate as in the display device 100, as shown in FIG. 9, when the transmitted light TL that corresponds to the incident light IL (external light OL) transmitted through the first circularly polarizing plate 40 is reflected at the reflection plate 15, the reflected light RL rotates in the opposite direction to that of the incident light IL (transmitted light TL) (that is, right-handed rotation is changed to left-handed rotation, for example). Therefore, the reflection light RL cannot be transmitted through the first circularly polarizing plate 40, thus preventing external light reflection.

### Modified Example 1

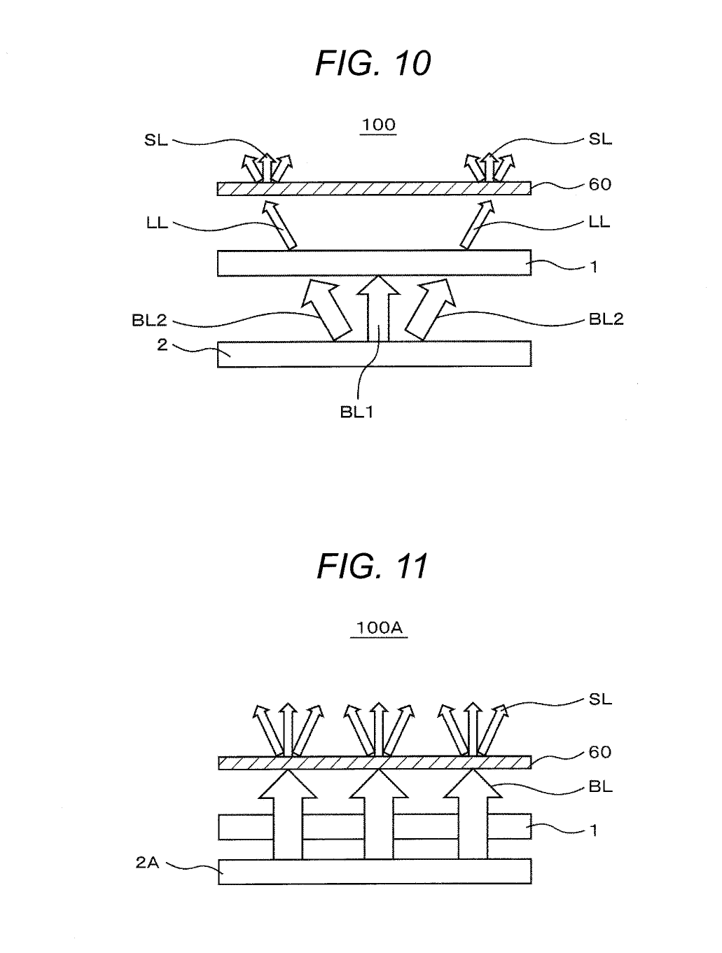

The first modified example (Modified Example 1) of the display device according to the embodiment is described with reference to FIGS. 10 to 12.

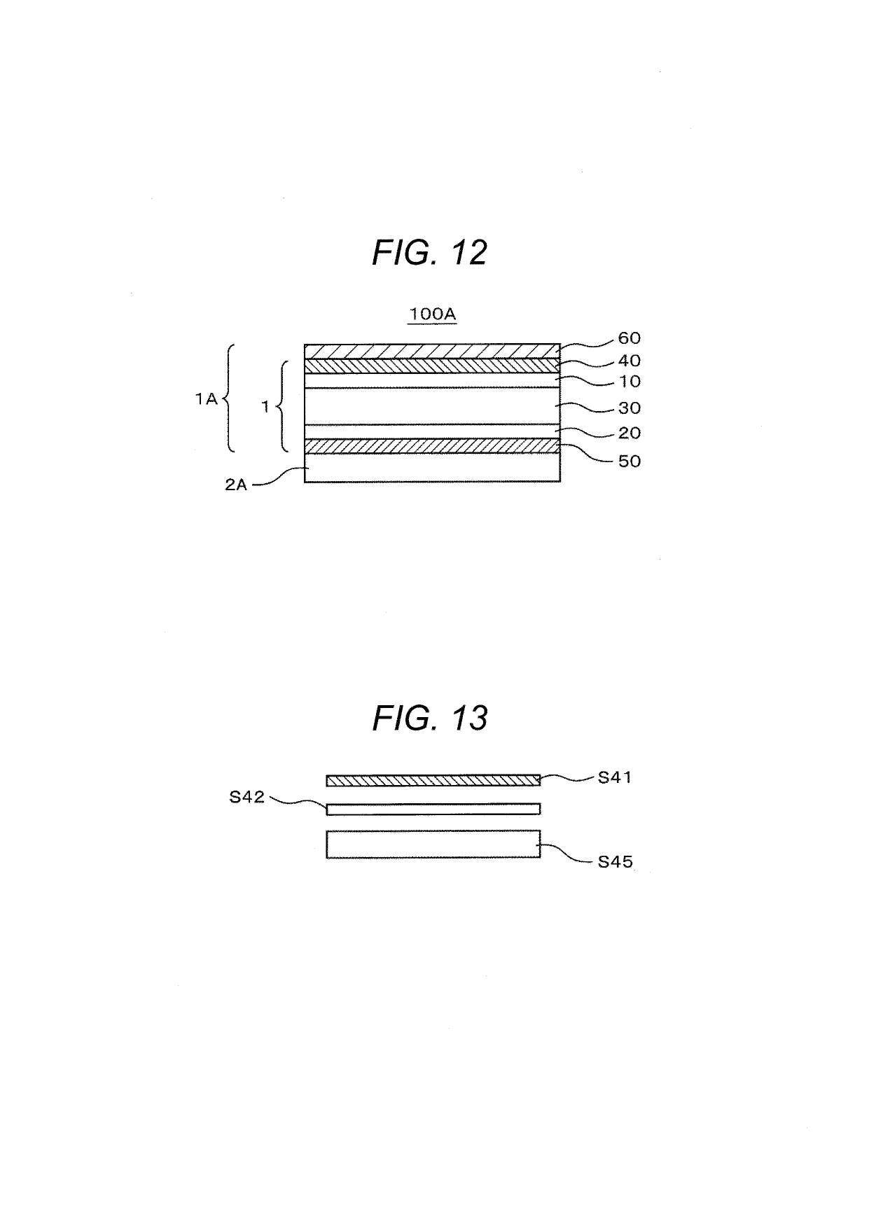

FIG. 10 is a schematic diagram for explaining a display device of Modified Example 1. FIG. 11 is a schematic diagram for explaining the effects of the display device of Modified Example 1. FIG. 12 is a cross-sectional view for explaining the display device of Modified Example 1.

In a general liquid crystal display device, the amount of modulation of light by the liquid crystal is different between light transmitted to the front and obliquely transmitted light, and therefore the appearance is different. This is referred to as so-called viewing angle characteristics. In a case of using the backlight 2 emitting light having some spread, even when the display panel 1 displays black as shown in FIG. 10, for example, front light BL1 that is emitted in the substrate's normal direction is sufficiently blocked by the display panel 1 whereas oblique light BL2 maybe transmitted through the display panel 1 because of the viewing angle characteristics. This leak light LL of the display panel 1 is scattered by the scattering film 60 also in the front direction to cause scattered light SL which may lower the contrast ratio. Therefore, for reducing the scattered light SL, it is desirable that the light BL emitted from the backlight is collimated (condensed) as highly as possible, as shown in FIG. 11. The display device 100A according to Modified Example 1 uses a light-condensing backlight 2A and a display panel 1A that is the same as that of the display device 100 of the embodiment, as shown in FIG. 12. The backlight 2A may be formed by an LED, a light guide, or a prism sheet, for example, like the backlight 2. The prism sheet is included to collimate the light more highly. The backlight 2A may be a light-condensing backlight that is configured in another manner.

Since the display device of Modified Example 1 uses the light-condensing backlight in the display device according to the embodiment, it can improve the contract ratio.

### Modified Example 2

The second modified example (Modified Example 2) of the display device according the embodiment is described with reference to FIGS. 13 to 17.

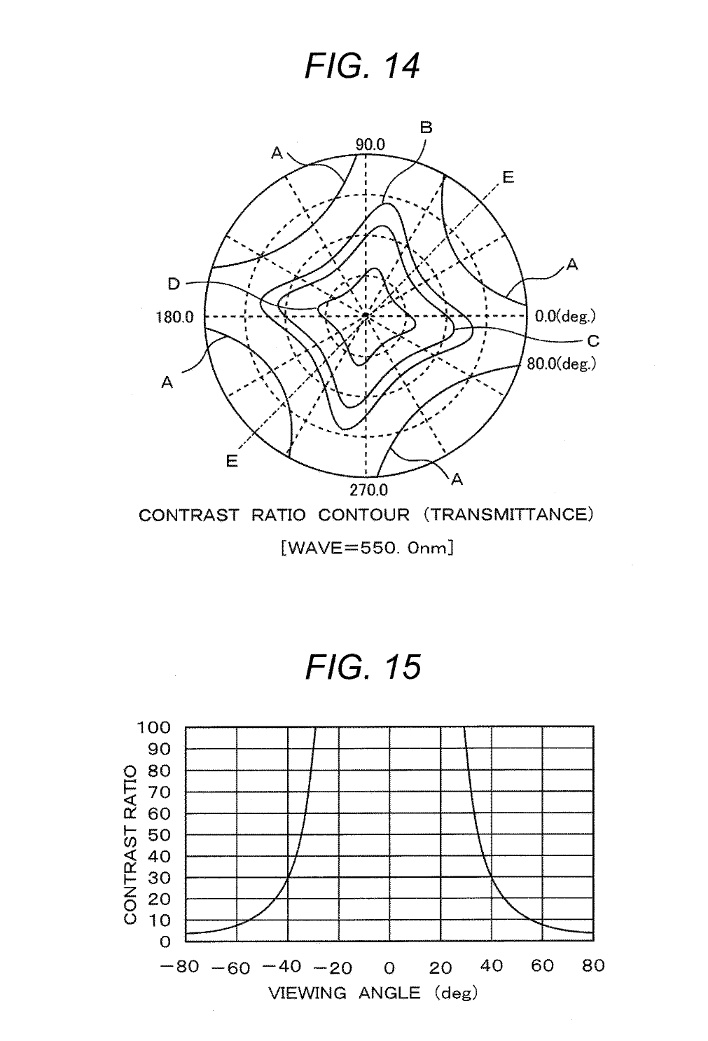

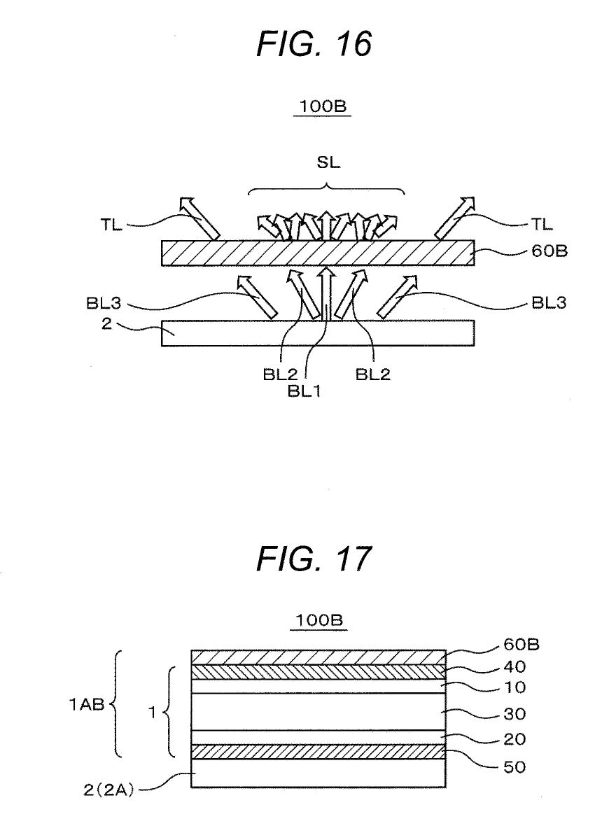

FIG. 13 shows a simulation model. FIG. 14 shows a calculation result of a contract-ratio chart. FIG. 15 shows viewing angle characteristics of the contract ratio at an azimuth of 45 degrees. FIG. 16 is a schematic diagram for explaining the display device of Modified Example 2. FIG. 17 is a cross-sectional view for explaining the display device of Modified Example 2.

A circularly polarizing plate has wavelength dependence and viewing angle dependence. First, the viewing angle characteristics are considered. As shown in FIG. 13, the simulation model formed by a linearly polarizing plate S41, a quarter-wave plate S42, and a reflection plate S45 was prepared. The quarter-wave plate S42 was designed to provide a phase difference of 137.5 nm and to have its optical axis arranged at an angle of 0 degree or 45 degrees to the linearly polarizing plate S41. This design was made for providing light having a wavelength of 550 nm with a phase difference of ¼ of the wavelength. FIG. 14 shows the calculation result of the contrast-ratio chart. The contrast ratio was obtained while assuming that white display was obtained when the optical axis of the quarter-wave plate S42 was arranged at an angle of 0 degree, and black display was obtained when that optical axis was arranged at an angle of 45 degrees. Light is made incident from above the linearly polarizing plate S41, is transmitted through the quarter-wave plate S42, is reflected by the reflection plate S45, is transmitted through the quarter-wave plate S42, and is emitted to the above the linearly polarizing plate S41. The calculation was made for various angles (azimuth angles and polar angles) of incidence of the light on the linearly polarizing plate S41 from above.

The outermost curve A in the contrast-ratio chart shown in FIG. 14 represents an angle providing a contrast ratio of 10:1. The curve B represents an angle providing a contrast ratio of 50:1. The curve C represents an angle providing a contrast ratio of 100:1. The curve D represents an angle providing a contrast ratio of 1000:1. In FIG. 14, 0.0 (deg), 90.0 (deg), 180.0 (deg), and 270.0 (deg) represent azimuth angles from the center of the circle. Concentric circles represent polar angles at intervals of 20.0 (deg) in which the innermost circle represents 20.0 (deg) and the outermost circle represents 80.0 (deg). FIG. 15 shows a cross-section of the characteristics of FIG. 14 at the azimuth angle of 45 degrees (taken along line E-E). FIG. 15 shows the contract ratio for an observation angle with respect to the front as a reference, and this angle corresponds to an angle of incidence of light with respect to the front. As found from FIG. 15, when light is incident at an angle of 60 degrees or more, the contract ratio is 10:1 or lower. With the contract ratio of 10:1 or lower, the display quality is degraded. Moreover, when light is incident at an angle of 80 degrees or more, the contrast ratio is 5:1 or lower and the display quality is significantly degraded. That is, when light providing a low contrast ratio is scattered to the front direction, the contrast ratio in the front direction is degraded. Therefore, when external light that is incident at an angle of 60 degrees or more is scattered by the scattering film, the contrast ratio is degraded in a bright environment. Moreover, when external light that is incident at an angle of 80 degrees or more is scattered by the scattering film, the contrast ratio is significantly degraded in the bright environment. Similarly to the above-described reflection of external light, when light from the backlight is incident at a deep angle, the contrast ratio in a dark environment is degraded. The incident angle of the light on the linearly polarizing plate S41 from the above may be replaced with the incident angle of light from the backlight side. When the light from the backlight incident at an angle of 60 degrees or more is scattered by the scattering film, the contrast ratio in the dark environment is degraded. Moreover, when the light from the backlight that is incident at an angle of 80 degrees or more is scattered by the scattering film, the contrast ratio is significantly degraded in the dark environment.

Thus, in order to fully use the characteristics of the circularly polarizing plate, as shown in FIG. 16, it is desirable to transmit light BL3 incident at a deep angle without scattering it and to scatter only light BL1 and light BL2 that are incident at shallow angles. Therefore, the scattering film 60B of Modified Example 2 has a feature of having characteristics that it does not scatter light having an incident angle of 80 degrees or more, more desirably 60 degrees or more. Such a scattering film 60B can be achieved by using a scattering film formed by hologram or a structure, for example. The scattering film formed by the structure may be a film described in Reference 1 (the content of which is incorporated herein by reference into this specification). The scattering film may have azimuth angle anisotropy, and can obtain the effect even when the above condition is satisfied in only one direction, for example. Moreover, in a case where the scattering film has azimuth angle anisotropy for the scattering intensity as in a so-called anisotropic diffusion film, the above effect can be also obtained.

Reference 1: K. Kusama, et at., “Light-Diffusing Films Using Two-step UV Irradiation for Various Displays”, SID 2013 Digest, P-49, (2013), pp. 1177 to 1180

For easy understanding, transmission of light while light is scattered is referred to as scattered transmission and transmission of light while light is not scattered is referred to as linear transmission. The display device of Modified Example 2 includes the scattering film that allows linear transmission for light having an incident angle of 80 degrees or more and scattered transmission only for light having an incident angle of less than 80 degrees and, more desirably, can allow linear transmission for light having an incident angle of 60 degrees or more and scattered transmission for light having an incident angle of less than 60 degrees in the display device according to the embodiment, thereby being able to improve the contrast ratio in both the bright environment and the dark environment.

As shown in FIG. 17, the display device 100B of Modified Example 2 uses the scattering film 60B, and the display panel 1 and the backlight 2 that are the same as those of the display panel 100 according to the embodiment. That is, the display panel 1AB of Modified Example 2 corresponds to the display panel 1 with the scattering film 60B attached thereto. In place of the backlight 2, the backlight 2A of the display device 100B according to Modified Example 1 may be used.

Even the backlight 2 that provides more poorly collimated light than the light-condensing backlight 2A can improve the viewing angle characteristics by being used with the scattering film 60B of Modified Example 2. Moreover, it is possible to further improve the viewing angle characteristics by using the scattering film 60B of Modified Example 2 together with the light-condensing backlight 2A.

### Modified Example 3

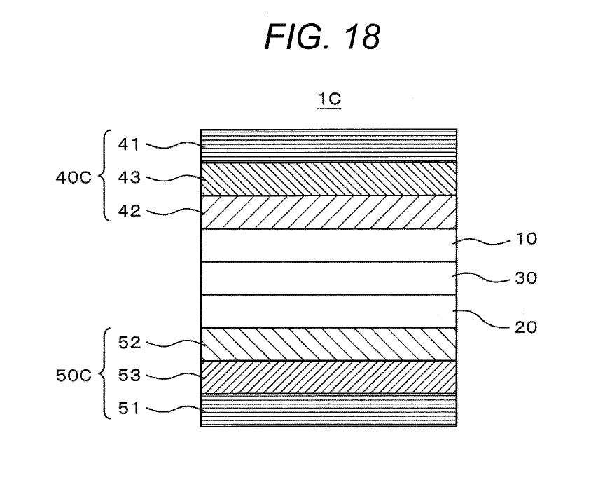

The third modified example (Modified Example 3) of the display device according to the embodiment is described with reference to FIGS. 18 to 20.

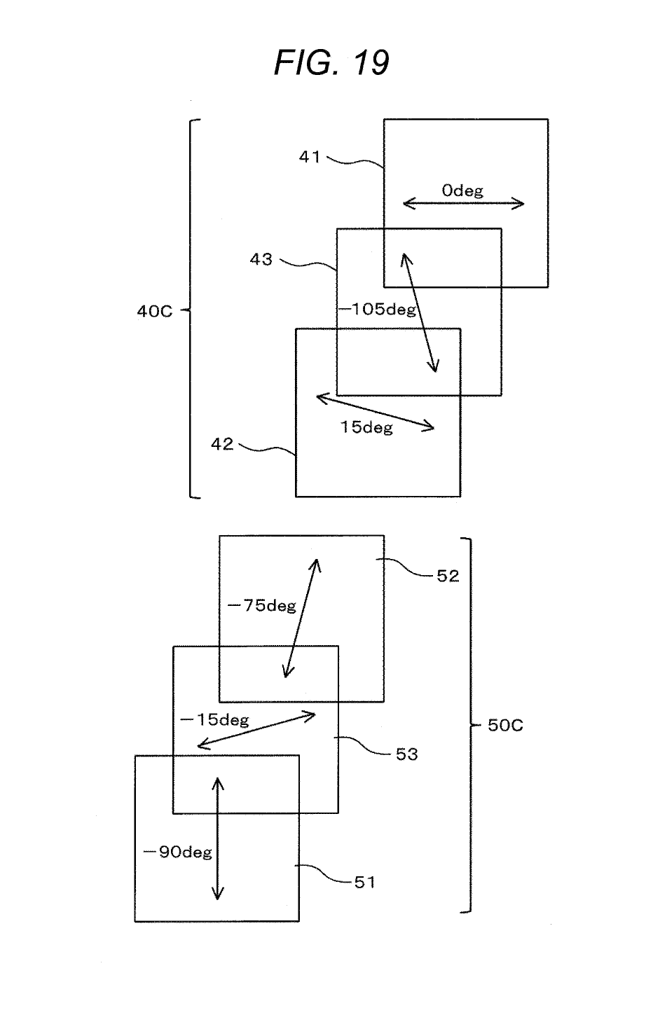

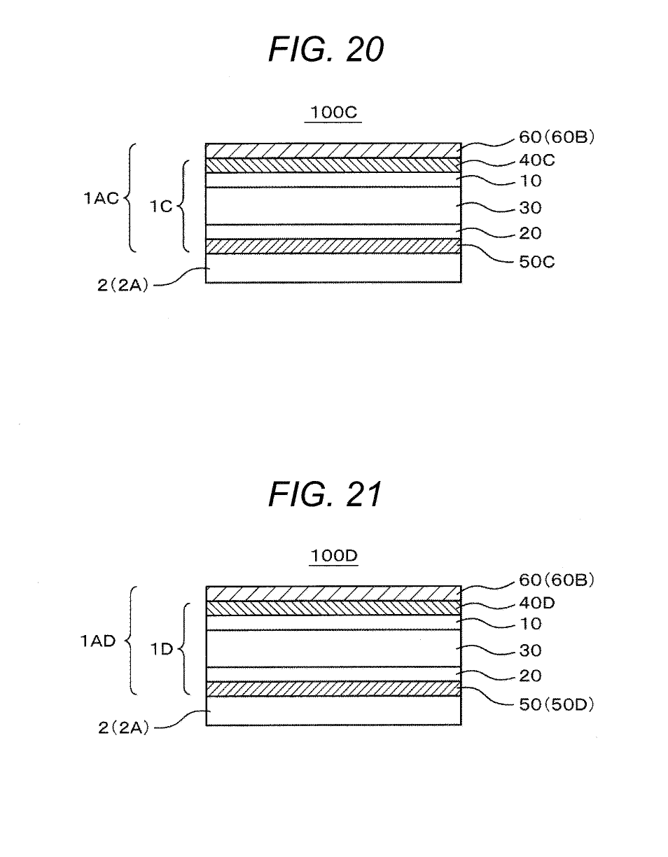

FIG. 18 is a cross-sectional view for explaining a broad-band circularly polarizing plate according to Modified Example 3. FIG. 19 is a schematic diagram for explaining the broad-band circularly polarizing plate according to Modified Example 3. FIG. 20 is a cross-sectional view for explaining a display device according to Modified Example 3.

As described above, a circularly polarizing plate is formed by a linearly polarizing plate and a quarter-wave plate. The quarter-wave plate is usually designed for light of 550 nm that is the highest in our light sensitivity, for example. In a case where this design is used, light other than the light of 550 nm is not completely circularly polarized (but is elliptically polarized). Thus, when external light having a wavelength other than 550 nm is incident, the resultant reflected light is not absorbed in the circularly polarizing plate but is observed as the reflected light. For solving this problem, the broad-band circularly polarizing plate may be used. As shown in FIG. 18, a first circularly polarizing plate 40C is formed by a linearly polarizing plate 41, a half-wave plate 43, and a quarter-wave plate 42 bonded to one another, for example. A second circularly polarizing plate 50C is formed by a linearly polarizing plate 51, a half-wave plate 53, and a quarter-wave plate 52 bonded to one another, for example. The first circularly polarizing plate 40C is arranged in such a manner that the quarter-wave plate 42 and the half-wave plate 43 are arranged on the side of incidence of the light from the backlight 2 and the linearly polarizing plate 41 is arranged on the light-exiting side (observer's sides). The second circularly polarizing plate 50C is arranged in such a manner that the linearly polarizing plate 51 is arranged on the side of incidence of the light from the backlight 2 and the half-wave plate 53 and the quarter-wave plate 52 are arranged on the light-exiting side. In a case of a VA mode, for example, as shown in FIG. 19, the optical axis of the linearly polarizing plate 41 is set to 0 degree, that of the half-wave plate 43 is set to approximately −105 degrees, that of the quarter-wave plate 42 is set to approximately 15 degrees, that of the quarter-wave plate 52 is set to approximately −75 degrees, that of the half-wave plate 53 is set to approximately −15 degrees, and that of the linearly polarizing plate 51 is set to approximately −90 degrees. Please note that “approximately” is used for describing a range of a strict angle plus or minus less than 5 degrees. The error from the strict angle is preferably in a range of plus or minus less than 3 degrees. The effects described here can be obtained by a polarizing plate having any shape, as long as that polarizing plate can provide circularly polarized light in a broad band of wavelengths. Moreover, also in case of using a film having a refractive index of which the wavelength dependence is reverse to that of the normal one (so-called reverse dispersion film), the same effects can be obtained.

The display device of Modified Example 3 can further improve the contrast ratio in the bright environment and the dark environment by using the broad-band circularly polarizing plate as the circularly polarizing plate in the display device according to the embodiment.

The display device 100C of Modified Example 3 uses the first broad-band circularly polarizing plate 40C and the second broad-band circularly polarizing plate 50C, and for other components, uses the same components as those in the display device 100 according to the embodiment. That is, a display panel 1C of Modified Example 3 is obtained by replacing the first circularly polarizing plate 40 and the second circularly polarizing plate 50 in the display panel 1 with the first broad-band circularly polarizing plate 40C and the second broad-band circularly polarizing plate 50C. Moreover, a display panel 1AC of Modified Example 3 corresponds to the display panel 1C with the scattering film 60 attached thereto. The backlight 2 may be replaced with the backlight 2A of the display device 100A of Modified Example 1, and the scattering film 60 may be replaced with the scattering film 60B of the display device 100B of Modified Example 2.

### Modified Example 4

The fourth modified example (Modified Example 4) of the display device according to the embodiment is described with reference to FIGS. 21 to 23.

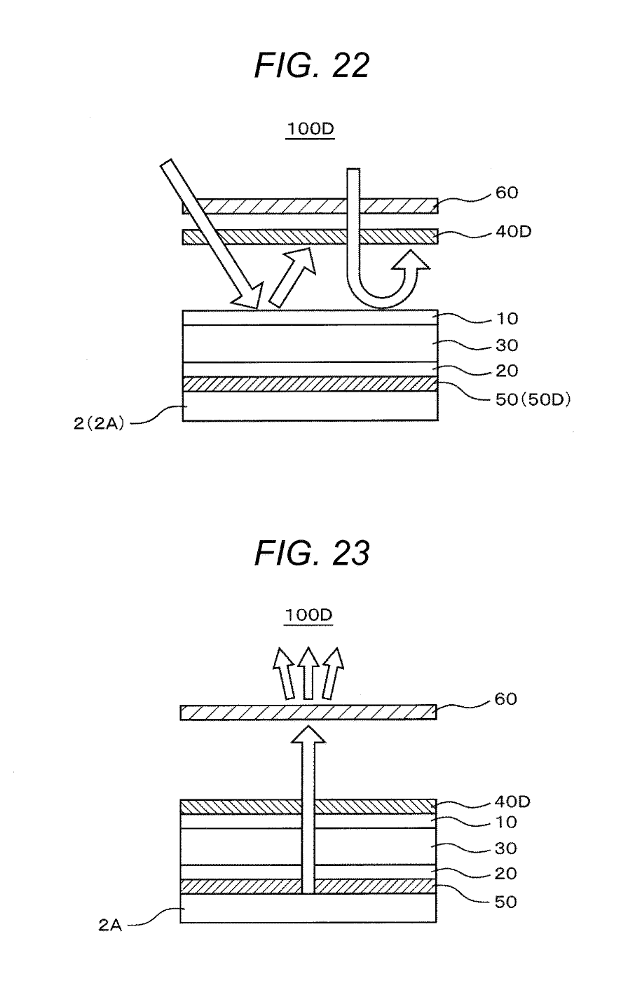

FIG. 21 is a cross-sectional view for explaining a display device of Modified Example 4. FIG. 22 is a schematic diagram for explaining the effects of the display device of Modified Example 4. FIG. 23 is a schematic diagram for explaining the display device of Modified Example 4. The display device 100D of Modified Example 4 can further improve the contrast ratio in the bright environment and the dark environment by improving the viewing angle characteristics of the circularly polarizing plate on the incident side in the display device according to the embodiment.

As shown in FIG. 21, the display device 100D uses a wide viewing angle circularly polarizing plate, and for other components, uses the same components as those in the display device 100 according to the embodiment. That is, a display panel 1D of Modified Example 4 corresponds to the display panel 1 in which the first circularly polarizing plate 40 is replaced with a first wide viewing angle circularly polarizing plate 40D. Moreover, a display panel 1AD of Modified Example 4 corresponds to the display panel 1D with the scattering film 60 attached thereto.

Even for external light incident at a deep angle, its reflected light is not scattered, because the wide viewing angle circularly polarizing plate 40D is used, as shown in FIG. 22. The same effect can be also obtained by using the scattering film 60B that can prevent light having a deep incident angle from being scattered. As the wide viewing angle circularly polarizing plate 40D, a biaxial quarter-wave plate may be used. More specifically, it is desirable that the quarter-wave plate has a Nz coefficient of 0.5.

In addition, as the second circularly polarizing plate on the backlight side, it is not necessary to use the wide viewing angle circularly polarizing plate when the backlight 2A that can provide collimated light is used, because that collimated light is incident on the panel perpendicularly thereto as shown in FIG. 23. However, the use of the second wide viewing angle circularly polarizing plate 50D can also provide the same effect.

What is claimed is:

1. A display device comprising:
a display panel; and
a backlight,
wherein the display panel includes:
a first substrate;
a second substrate;
a liquid crystal layer sandwiched between the first and second substrates;
a first circularly polarizing plate arranged on an observer's side of the first substrate;
a second circularly polarizing plate arranged between the second substrate and the backlight, and
a scattering film arranged on an observer's side of the first circularly polarizing plate.

2. The display device according to claim 1, wherein the backlight is a light-condensing backlight.

3. The display device according to claim 1, wherein the scattering film is configured to transmit light from front thereof while scattering it, and to linearly transmit light incident thereon at a certain angle or more.

4. The display device according to claim 3, wherein the light linearly transmitted through the scattering film is light incident at an angle of 80 degrees or more.

5. The display device according to claim 3, wherein the light linearly transmitted through the scattering film is light incident at an angle of 60 degrees or more.

6. The display device according to claim 1, wherein the scattering film is formed by hologram or a structure.

7. The display device according to claim 3, wherein the scattering film has anisotropy of scattering intensity in an azimuth angle direction.

8. The display device according to claim 1, wherein the first and the second circularly polarizing plates are broad-band circularly polarizing plates.

9. The display device according to claim 8, wherein the broad-band circularly polarizing plate is a combination of a linearly polarizing plate, a half-wave plate, and a quarter-wave plate.

10. The display device according to claim 1, wherein the first circularly polarizing plate has a wider viewing angle than the second circularly polarizing plate.

11. A display device comprising:
a display panel; and
a backlight,
wherein the display panel includes :
a first substrate;
a second substrate;
a liquid crystal layer sandwiched between the first and second substrates;
a first polarizing plate arranged on an observer's side of the first substrate;
a second polarizing plate arranged between the second substrate and the backlight; and
a scattering film arranged on an observer's side of the first polarizing plate,
the first polarizing plate is formed by a first linearly polarizing plate and a first quarter-wave plate, and an angle formed by an optical axis of the first linearly polarizing plate and an optical axis of the first quarter-wave plate is approximately 45 degree, and
the second polarizing plate is formed by a second linearly polarizing plate and a second quarter-wave plate, and an angle formed by an optical axis of the second linearly polarizing plate and an optical axis of the second quarter-wave plate is approximately −45 degree.

12. The display device according to claim 11, wherein the backlight is a light-condensing backlight.

13. The display device according to claim 11, wherein the scattering film is configured to transmit light incident thereon at an angle smaller than a predetermined angle with respect to a front direction while scattering it, and to linearly transmit light incident thereon at the predetermined angle or more.

14. The display device according to claim 13, wherein the predetermined angle is 80 degrees.

15. The display device according to claim 13, wherein the predetermined angle is 60 degrees.

16. The display device according to claim 11, wherein the scattering film is formed by hologram or a structure.

17. The display device according to claim 11, wherein the scattering film has anisotropy of scattering intensity in an azimuth angle direction

18. The display device according to claim 11,
wherein the first polarizing plate includes a first half-wave plate between the first linearly polarizing plate and the first quarter-wave plate, and
the second polarizing plate includes a second half-wave plate between the second linearly polarizing plate and the second quarter-wave plate.
